(19) United States
(12) Patent Application Publication
(10) Pub. No.: US 2018/0315067 A1
(43) Pub. Date: Nov. 1, 2018

(54) SYSTEM, METHOD, AND COMPUTER PROGRAM FOR PROVIDING A CARD-LINKED OFFER NETWORK THAT ENABLES A CONSUMER TO LINK THE SAME PAYMENT CARD TO THE SAME OFFER ON MULTIPLE DIFFERENT PUBLISHER SITES

(71) Applicant: Ebates Inc., San Mateo, CA (US)

(72) Inventors: Norman Shi, Los Altos, CA (US); Chris Osborn, Solana Beach, CA (US); Todd Herrold, San Francisco, CA (US); Matt Houser, San Diego, CA (US); Devin Ross, San Diego, CA (US)

(21) Appl. No.: 15/961,440

(22) Filed: Apr. 24, 2018

Related U.S. Application Data
(60) Provisional application No. 62/490,199, filed on Apr. 26, 2017.

(51) Int. Cl. G06Q 30/02; G06Q 20/34

(52) U.S. Cl. CPC G06Q 30/0215; G06Q 30/0226; G06Q 20/34

(57) ABSTRACT

The present disclosure describes a computer program, system, and method for providing a card-linked offer network. A system on which the network is hosted enables consumers to link the same payment card to the same card-linked offer (CLO) on multiple different publisher sites. In response to a purchase transaction satisfying the terms of an accepted CLO, the system identifies the publishers associated with the acceptance of the CLO by the consumer. The system applies one or more rules to determine which publisher to credit with the transaction.

### RELATED APPLICATIONS

This application claims the benefit of U.S. Provisional Application No. 62/490,199, filed on Apr. 26, 2017, and titled “System, Method, and Computer Program for Providing a Card-Linked Offer Network that Enables a Consumer to Register the Same Payment Card with Multiple Publishers and to Link the Payment Card to the Same Offer on Multiple Publisher Sites,” the contents of which are incorporated by reference herein as if fully disclosed herein.

### BACKGROUND OF THE INVENTION

### 1. FIELD OF THE INVENTION

This invention relates generally to card-linked offer networks, and, more specifically, to providing a card-linked offer network that enables a consumer to link a payment card to the same offer on multiple publisher sites.

### 2. DESCRIPTION OF THE BACKGROUND ART

Card-linked offers (CLOs) are digital offers or coupons linked to a credit card. CLOs may be published via a CLO network accessible to multiple publishers and multiple merchants. Specifically, publishers register with a CLO network. Merchants post CLOs on the CLO network, and they “enable” select publishers to publish their CLOs.

Publishers publish the CLOs on online sites (e.g., websites, mobile applications). Often different publishers will publish the same CLO. Consumers are able to accept a CLO on a publisher site. Specifically, a consumer registers a payment card with a publisher and, in accepting a CLO, links the payment card to the CLO. If the consumer makes a qualifying purchase at the merchant associated with the CLO using the linked payment card, the consumer is credited with the reward terms of the accepted CLO.

If a consumer links the offer multiple times to a card, the user could receive the discount/offered reward multiple time, which is not desired by merchants. This is often referred to as a the “stackable-offer problem.” Known CLO networks address this problem by prohibiting users from registering a card on multiple publisher sites. In such networks, if a user attempts to enable (register) the card on multiple publisher sites, the attempted registration will be rejected. A consumer must delete their card on the prior site, and then re-enter it on the current site to enroll. This results in a poor consumer experience. Consequently, there is market demand for a CLO network that provides an alternate solution to the stackable offer problem.

### SUMMARY OF THE DISCLOSURE

The present disclosure describes a computer program, system, and method for providing a card-linked offer network. A system on which the network is hosted enables consumers to register a payment card on multiple merchant sites and to link the payment card to the same card-linked offer (CLO) on multiple different publisher sites.

Merchants post CLOs on the network, and publishers publish the CLOs on their online sites (e.g., website, mobile applications). Consumers are able to accept CLOs via the sites.

Each time a consumer accepts a CLO on a publisher site using a payment card, the system associates the consumer's payment card with both the publisher and the CLO in a database or other storage device. Unlike prior art CLO networks, the system does not reject any attempts to register the same card or accept the same CLO on another publisher site. Instead, if a consumer links the same payment card to the same CLO on multiple different publisher sites, the system associates the same payment card/CLO pair with multiple publishers.

The system periodically parses purchase transaction information from a payment card network for the purpose of identifying transactions that satisfy the terms of accepted CLOs. In response to detecting a transaction satisfies an accepted CLO, the system identifies the publisher linked to the payment card in the transaction and to the consumer's acceptance of the CLO. If the consumer accepted the CLO at multiple publishers using the applicable payment card, the system applies one or more rules to select the publisher to credit with the transaction. For instance, the system may select the last publisher through which the consumer accepted the CLO. The system disregards the other instances of the CLO being accepted at other publishers by the same consumer. Because the system applies rules for selecting a publisher, it is able to allow a consumer to link the payment card to the same offer on multiple different publisher sites while still addressing the stackable-offer problem.

In certain embodiments, a method for providing a card-linked offer network comprises the following steps:

providing a card-linked offer (CLO) network accessible to multiple different content publishers and multiple different merchants, wherein merchants are able to post card-linked offers (CLOs) on the CLO network, wherein publishers are able to publish online CLOs posted by merchants on the CLO network, wherein consumers are able to accept CLOs via publishers' online interfaces, wherein consumers are able to enable the same payment card on multiple publisher sites, and wherein consumers are able to link the payment card to the same offer on different publisher sites;

for each CLO posted on the CLO network, creating an offer ID that uniquely identifies the CLO and that is associated with offer terms and a merchant ID, wherein the merchant ID uniquely identifies the merchant that posted the CLO;

receiving a first notice of a consumer acceptance of a CLO on a first publisher site, wherein the notice includes a publisher ID associated with the first publisher site, the offer ID for the accepted CLO, and the consumer's payment card identifier;

associating the consumer's payment card identifier with (1) the offer ID of the accepted CLO, (2) the merchant ID associated with the accepted CLO, and (3) and the publisher ID for the first publisher;

registering the payment card identifier/merchant ID pair associated with the accepted CLO with the payment card network for purchase of receiving transaction information for transactions involving the payment card identifier/merchant ID pair;

receiving one or more subsequent notices of consumer acceptance of the same CLO on other publisher sites using the same payment card identifier;

for each subsequent notice, associating the payment card identifier, offer ID, and merchant ID associated with the accepted CLO with a publisher ID for the subsequent publisher, resulting in the same payment card identifier/offer ID/ merchant ID combination being associated with multiple publishers;
receiving from the payment card network information related to a transaction matching the registered payment card identifier/merchant ID pair;

determining that the transaction satisfies the terms of the accepted CLO;

identifying a plurality of publishers associated with the accepted CLO and payment card identifier;

applying one or more rules for selecting a publisher to credit with the transaction; and crediting the selected publisher with the transaction.

### BRIEF DESCRIPTION OF THE DRAWINGS

FIG. 1 is a flowchart that illustrate a method, according to one embodiment, for linking payment cards and publishers to CLOs in a CLO network.

FIGS. 2 is a flowchart that illustrate a method, according to one embodiment, for crediting consumers and publishers for transactions that satisfy the terms of accepted CLOs.

FIG. 3 is a block diagram that illustrates an example CLO network according to one embodiment.

FIG. 4 is a block diagram that illustrates an example software architecture for a computer system that hosts and provides a CLO network according to one embodiment.

### DETAILED DESCRIPTION OF THE PREFERRED EMBODIMENTS

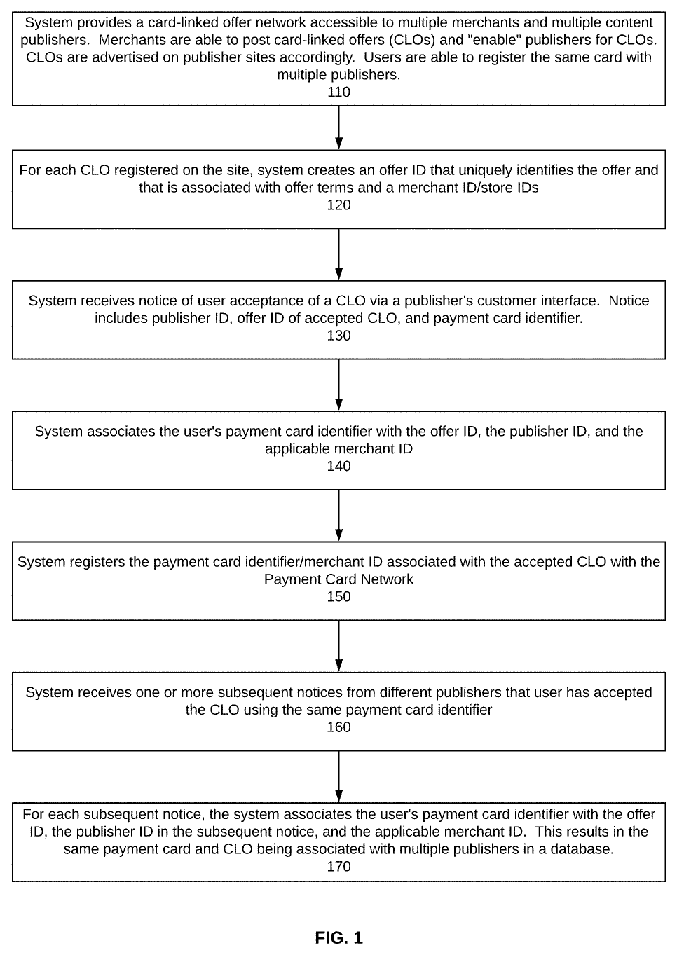

The present disclosure relates to a system, method, and computer program product for providing a CLO network that enables a consumer to link a payment card to the same offer on multiple publisher sites. The method is described with respect to FIG. 1-4.

1. Processing Consumer Acceptance of CLOs

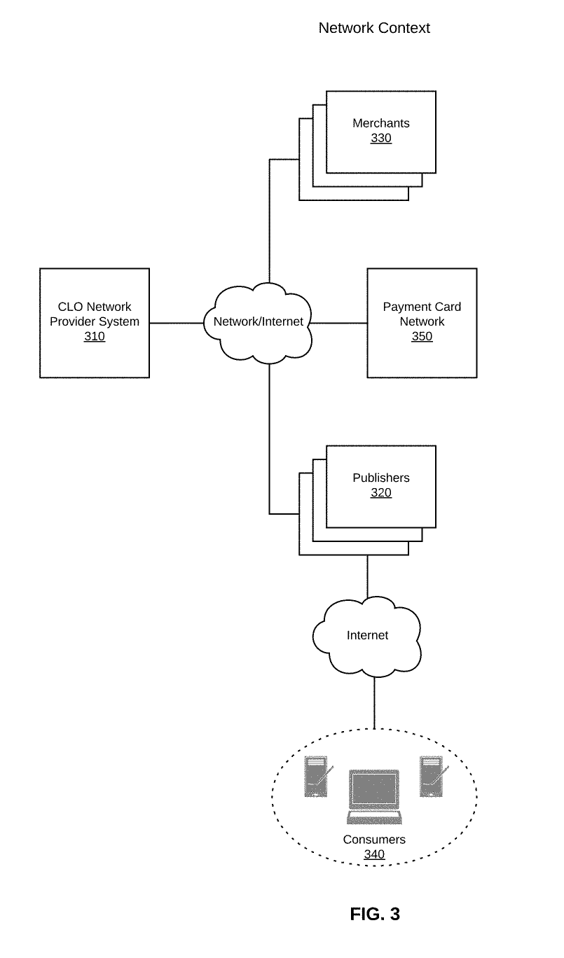

FIG. 1 illustrates the steps, according to one embodiment, associated with linking payment cards and publishers to CLOs in the CLO network. The CLO network is hosted on a computer system (“the system”), such as system 310 (FIG. 3). The system provides a CLO network accessible to multiple content publishers (e.g., publishers 320) and multiple merchants (e.g., merchants 330) (step 110). Publishers are entities that provide websites, mobile applications, or other online content for viewing by consumers. Examples of publishers' sites include news website, social media websites, social blogs, and loyalty provider websites.

Publishers register with the CLO network, and merchants post CLOs on the network (or a system administrator post CLOs on behalf of merchants). For each CLO posted by a merchant, the merchant “enables” one or more registered publishers for the CLO. Enabled publishers are able to publish the CLO.

Consumers 340 register payments card with publishers in order to accept CLOs via publishers' online interfaces (e.g., websites, mobile apps). The system allows consumers to register the same payment card with multiple publishers.

Each merchant that posts CLOs on the network is associated with a unique merchant ID. The merchant ID is the same merchant ID used by the payment card network, which processes credit card transactions, to identify merchants.

For each CLO registered on the site, the system creates an offer ID that uniquely identifies the offer and that is associated with offer terms and a merchant ID (step 120). It some cases, the offer may be associated with one or more store IDs instead or in addition to a merchant ID.

In response to a consumer accepting a CLO on a publisher site, the system receives electronic notice of the acceptance from the publisher (step 130). The notice includes the publisher ID, offer ID, and consumer's payment card identifier (e.g., credit card identifier). The system associates the consumer's payment card identifier with the following in a database: (1) the offer ID of the CLO, (2) the merchant ID associated with the CLO (and/or store ID if applicable), and (3) publisher ID in the notice (steps 140)

The system registers payment card identifier/merchant ID pairs associated with accepted CLOs with a payment card network (step 150). This is done to obtain information on purchase transactions with these pairs. In one embodiment, this step is performed only once for each unique payment card identifier/merchant ID pair, regardless of the number of accepted CLOs associated with a payment card identifier/merchant ID pair. For certain payment card processors, the system also registers the offer ID along with the payment card identifier/merchant ID pair.

In the scenario illustrated in FIG. 1, the consumer referenced in step 130 also accepts the same CLO via one or more other publisher sites using the same payment card. Consequently, the system receives one or more subsequent notices from different publishers that the consumer has accepted the CLO using the same payment card identifier (step 160). Unlike prior art CLO networks, the system does not reject these subsequent acceptances with the same payment card. Instead, for each subsequent notice, the system creates a new entry in the database associating the consumer's payment card identifier: with the following (1) the offer ID of the CLO, (2) the merchant ID associated with the CLO (and/or store ID if applicable), and (3) publisher ID in the subsequent notice (step 170). This results in the same payment card and CLO being associated with multiple publishers in the database.

2. Crediting Consumers and Publishers for Transactions that Satisfy Accepted CLOs

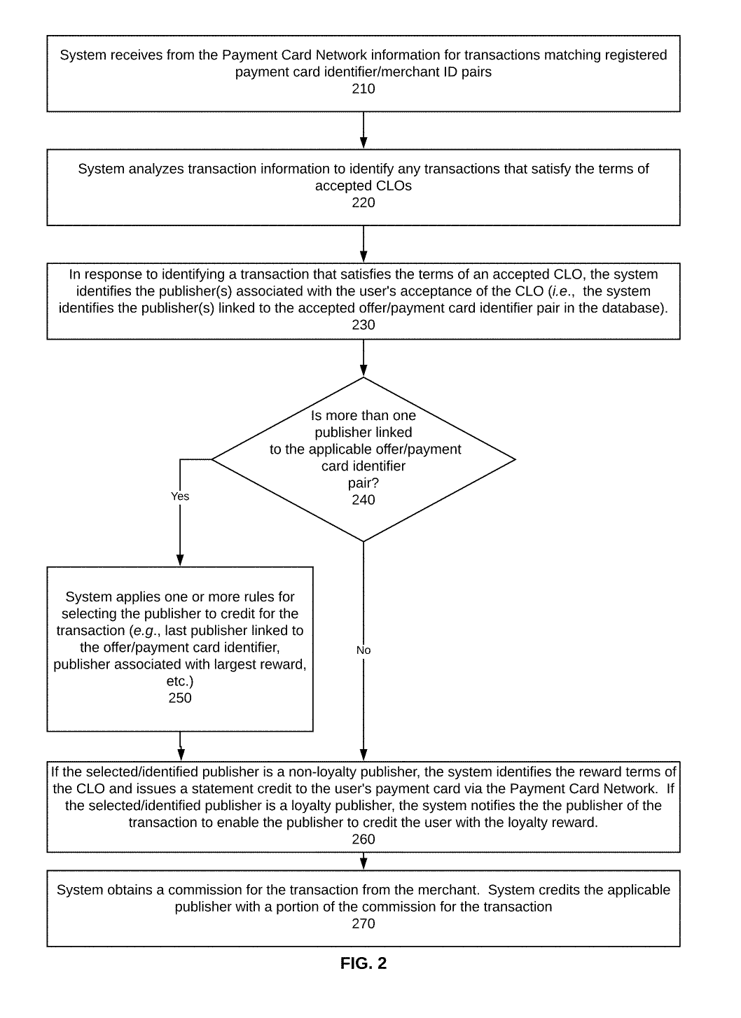

FIG. 2 illustrates the steps, according to one embodiment, associated with crediting consumers and publishers for transactions that satisfy the terms of accepted CLOs. Referring to FIG. 2, the payment card network sends the system information related to purchase transactions that match registered payment card identifier/merchant ID pairs (step 210).

The system analyzes the transaction information to identify any transactions that satisfy the terms of accepted CLOs (step 220). In response to identifying a transaction that satisfies the terms of an accepted CLO, the system identifies the publisher(s) associated with the consumer's acceptance of the CLO (step 230).

As a consumer can link the same payment card to the same offer on multiple different publisher sites, there may be more than one publisher associated with the user's acceptance of the CLO. If the consumer accepted the CLO at multiple publishers using the same payment card, the system applies one or more rules to select the publisher to credit for the transaction (steps 240, 250). In one embodiment, the system selects the last publisher through which the user accepted the CLO. In an alternate embodiment, the system ranks publishers first by the size of the reward earned by the user (e.g., in the case of loyalty publishers, the reward associated with the offer may depend on the publisher), and second by the recency in which the user accepted the CLO. For example, if one publisher offered a greater reward than the others, the system would select that publisher. However, if there was a tie between two publishers, then system would select the publisher on which the user last accepted the CLO.

If the publisher is a non-loyalty publisher, the system identifies the reward terms of the CLO and issues a statement credit to the consumer's payment card via the relevant payment card network (step 260). The credit is in accordance with the reward terms. If the publisher is a loyalty publisher (e.g., Ebates), the system notifies the loyalty publisher of the transaction to enable the loyalty publisher to credit the user with the loyalty reward (also step 260). A loyalty publisher, such as EBATES, publishes offers associated with its loyalty program (e.g., points, miles, cashback, etc.). In other words, the reward terms offered by a merchant relate to the publisher's loyalty program. Non-loyalty publishers (e.g., CNN, ABC) are not associated with a loyalty program, and the CLOs published by non-loyalty publishers are not related to any reward offered by the publisher. The rewards in CLOs published by non-loyalty publishers are a credit back on the linked payment card.

The system obtains a commission from the merchant for the transaction and credits the publisher associated with the accepted CLO with a portion of the commission for the transaction (step 270).

In a further embodiment of the CLO network, merchants may post overlapping offers, in which a consumer can apply only one of the offers to a transaction (e.g., free shipping or 15% off). Each offer is associated with a different offer ID. In the event the user accepts more than one of such offers via multiple publishers, the system identifies the offer that provides the greatest reward to the user and credits the publisher associated with that offer for the transaction. In other words, the system may identify multiple offers (each with a different offer ID) from the same merchant that are satisfied by the transaction, and the system selects the offers that most benefits the consumer. If the most beneficial offer to a consumer was accepted at multiple publishers, then system performs steps 240-250 to select one publisher to credit with the transaction.

The methods described herein are embodied in software and performed by a computer system (comprising one or more computing devices) executing the software. A person skilled in the art would understand that a computer system has one or more memory units, disks, or other physical, computer-readable storage media for storing software instructions, as well as one or more processors for executing the software instructions.

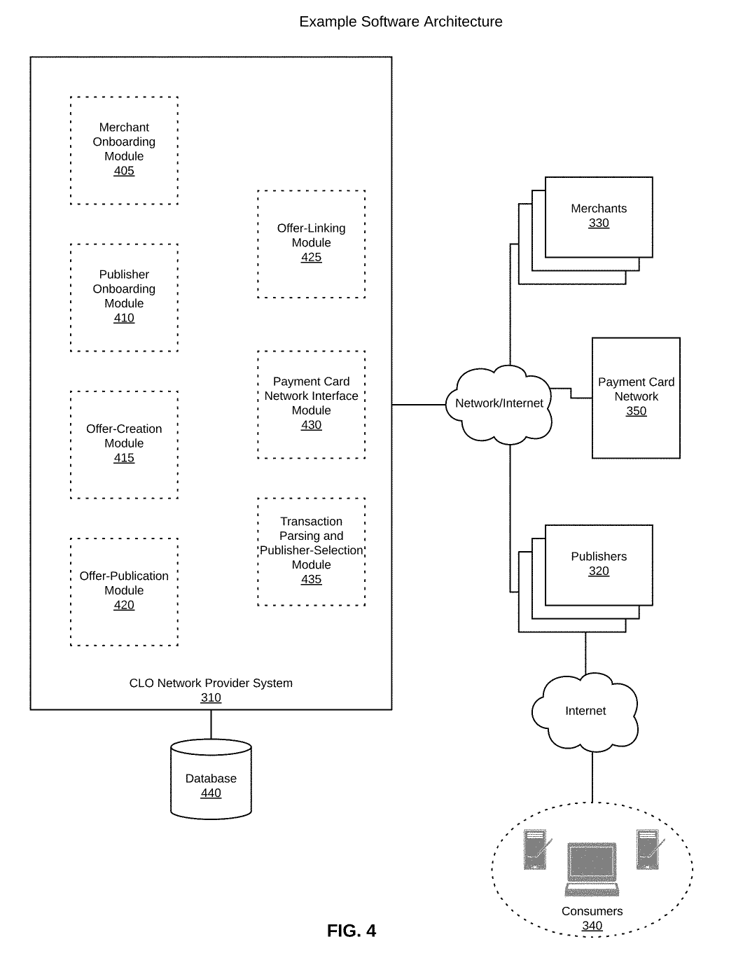

FIG. 4 illustrates an example software architecture for a system that provides a CLO network in accordance with the methods described herein (e.g., system 310). The architecture illustrated in FIG. 4 is an example, and the system could be implemented in other ways. The system of FIG. 4 includes the following modules:

Merchant Onboarding Module (405): Enables merchants to register for the CLO network.

Publisher Onboarding Module (410): Enables publishers to register for the CLO network.

Offer-Creation Module (415): Enables merchants and/or system administrators to create and enter offer information. In response to receiving a new CLO, creates offer ID and stores offer information in database 440 (e.g., offer ID, offer terms, associated merchant/store IDs).

Offer-Publication Module (420): Provides interface via which publishers can access offers in the CLO network for publication.

Offer-Linking Module (425): Receives notices from publishers of accepted CLOs. Links applicable payment card to the offer ID for the accepted CLO, the applicable publisher, and the corresponding merchant. Updates database 440 to reflect linking.

Payment Card Network Interface Module (430): Registers payment card identifier/merchant ID pairs associated with accepted offers with Payment Card Network 250. Receives from the Payment Card Network 350 transaction information related to the registered payment card identifier/merchant ID pairs.

Transaction Parsing and Publisher-Selection Module (435): Analyzes transaction information received from Payment Card Network 350 to identify transactions that satisfy terms of accepted card-linked offers. If one or more publishes are linked to the same offer/payment card ID pair, the module applies one or more rules to select the publisher to which the transaction is credited (e.g., last-linked publisher, publisher associated with most rewards, etc.).

As will be understood by those familiar with the art, the invention may be embodied in other specific forms without departing from the spirit or essential characteristics thereof. Accordingly, the above disclosure is intended to be illustrative, but not limiting, of the scope of the invention.

1. A method for providing a card-linked offer network that enables a consumer to link a payment card to the same offer on multiple publisher sites, the method comprising:
providing a card-linked offer (CLO) network accessible to multiple different content publishers and multiple different merchants, wherein merchants are able to post card-linked offers (CLOs) on the CLO network, wherein publishers are able to publish online CLOs posted by merchants on the CLO network, wherein consumers are able to accept CLOs via publishers' online interfaces, wherein consumers are able to enable the same payment card on multiple publisher sites, and wherein consumers are able to link the payment card to the same offer on different publisher sites;
for each CLO posted on the CLO network, creating an offer ID that uniquely identifies the CLO and that is associated with offer terms and a merchant ID, wherein the merchant ID uniquely identifies the merchant that posted the CLO;
receiving a first notice of a consumer acceptance of a CLO on a first publisher site, wherein the notice includes a publisher ID associated with the first publisher site, the offer ID for the accepted CLO, and the consumer's payment card identifier;
associating the consumer's payment card identifier with (1) the offer ID of the accepted CLO, (2) the merchant ID associated with the accepted CLO, and (3) and the publisher ID for the first publisher;
registering the payment card identifier/merchant ID pair associated with the accepted CLO with the payment card network for purchase of receiving transaction information for transactions involving the payment card identifier/merchant ID pair;
receiving one or more subsequent notices of consumer acceptance of the same CLO on other publisher sites using the same payment card identifier;
for each subsequent notice, associating the payment card identifier, offer ID, and merchant ID associated with the accepted CLO with a publisher ID for the subsequent publisher, resulting in the same payment card identifier/offer ID/ merchant ID combination being associated with multiple publishers;
receiving from the payment card network information related to a transaction matching the registered payment card identifier/merchant ID pair;
determining that the transaction satisfies the terms of the accepted CLO;
identifying a plurality of publishers associated with the accepted CLO and payment card identifier;
applying one or more rules for selecting a publisher to credit with the transaction; and crediting the selected publisher with the transaction.

2. The method of claim 1, wherein the last publisher via which the consumer accepted the CLO is selected.

3. The method of claim 1, wherein the publisher associated with a largest reward for the consumer is selected.

4. The method of claim 1, further comprising:
crediting the consumer with a reward in accordance with rewards terms for the CLO.

5. The method of claim 4, further comprising:
crediting the identified publisher with a commission for the transaction.

6. A non-transitory computer-readable medium comprising a computer program, that, when executed by a computer system, enables the computer system to perform the following method for providing a card-linked offer network that enables a consumer to link a payment card to the same offer on multiple publisher sites, the method comprising:
providing a card-linked offer (CLO) network accessible to multiple different content publishers and multiple different merchants, wherein merchants are able to post card-linked offers (CLOs) on the CLO network, wherein publishers are able to publish online CLOs posted by merchants on the CLO network, wherein consumers are able to accept CLOs via publishers' online interfaces, wherein consumers are able to enable the same payment card on multiple publisher sites, and wherein consumers are able to link the payment card to the same offer on different publisher sites;
for each CLO posted on the CLO network, creating an offer ID that uniquely identifies the CLO and that is associated with offer terms and a merchant ID, wherein the merchant ID uniquely identifies the merchant that posted the CLO;
receiving a first notice of a consumer acceptance of a CLO on a first publisher site, wherein the notice includes a publisher ID associated with the first publisher site, the offer ID for the accepted CLO, and the consumer's payment card identifier;
associating the consumer's payment card identifier with (1) the offer ID of the accepted CLO, (2) the merchant ID associated with the accepted CLO, and (3) and the publisher ID for the first publisher;
registering the payment card identifier/merchant ID pair associated with the accepted CLO with the payment card network for purchase of receiving transaction information for transactions involving the payment card identifier/merchant ID pair;
receiving one or more subsequent notices of consumer acceptance of the same CLO on other publisher sites using the same payment card identifier;
for each subsequent notice, associating the payment card identifier, offer ID, and merchant ID associated with the accepted CLO with a publisher ID for the subsequent publisher, resulting in the same payment card identifier/offer ID/ merchant ID combination being associated with multiple publishers;
receiving from the payment card network information related to a transaction matching the registered payment card identifier/merchant ID pair;
determining that the transaction satisfies the terms of the accepted CLO;
identifying a plurality of publishers associated with the accepted CLO and payment card identifier;
applying one or more rules for selecting a publisher to credit with the transaction; and crediting the selected publisher with the transaction.

7. The non-transitory computer-readable medium of claim 6, wherein the last publisher via which the consumer accepted the CLO is selected.

8. The non-transitory computer-readable medium of claim 6, wherein the publisher associated with a largest reward for the consumer is selected.

9. The non-transitory computer-readable medium of claim 6, further comprising:
crediting the consumer with a reward in accordance with rewards terms for the CLO.

10. The non-transitory computer-readable medium of claim 9, further comprising:
crediting the identified publisher with a commission for the transaction.

11. A computer system for method for providing a card-linked offer network that enables a consumer to link a payment card to the same offer on multiple publisher sites, the system comprising:
one or more processors;
one or more memory units coupled to the one or more processors, wherein the one or more memory units store instructions that, when executed by the one or more processors, cause the system to perform the operations of:
providing a card-linked offer (CLO) network accessible to multiple different content publishers and multiple different merchants, wherein merchants are able to post card-linked offers (CLOs) on the CLO network, wherein publishers are able to publish online CLOs posted by merchants on the CLO network, wherein consumers are able to accept CLOs via publishers' online interfaces, wherein consumers are able to enable the same payment card on multiple publisher sites, and wherein consumers are able to link the payment card to the same offer on different publisher sites;
for each CLO posted on the CLO network, creating an offer ID that uniquely identifies the CLO and that is associated with offer terms and a merchant ID, wherein the merchant ID uniquely identifies the merchant that posted the CLO;
receiving a first notice of a consumer acceptance of a CLO on a first publisher site, wherein the notice includes a publisher ID associated with the first publisher site, the offer ID for the accepted CLO, and the consumer's payment card identifier;
associating the consumer's payment card identifier with (1) the offer ID of the accepted CLO, (2) the merchant ID associated with the accepted CLO, and (3) and the publisher ID for the first publisher;
registering the payment card identifier/merchant ID pair associated with the accepted CLO with the payment card network for purchase of receiving transaction information for transactions involving the payment card identifier/merchant ID pair;
receiving one or more subsequent notices of consumer acceptance of the same CLO on other publisher sites using the same payment card identifier;
for each subsequent notice, associating the payment card identifier, offer ID, and merchant ID associated with the accepted CLO with a publisher ID for the subsequent publisher, resulting in the same payment card identifier/offer ID/ merchant ID combination being associated with multiple publishers;
receiving from the payment card network information related to a transaction matching the registered payment card identifier/merchant ID pair;
determining that the transaction satisfies the terms of the accepted CLO;
identifying a plurality of publishers associated with the accepted CLO and payment card identifier;
applying one or more rules for selecting a publisher to credit with the transaction; and crediting the selected publisher with the transaction.

12. The system of claim 11, wherein the last publisher via which the consumer accepted the CLO is selected.

13. The system of claim 11, wherein the publisher associated with a largest reward for the consumer is selected.

14. The system of claim 11, further comprising:
crediting the consumer with a reward in accordance with rewards terms for the CLO.

15. The system of claim 14, further comprising:
crediting the identified publisher with a commission for the transaction.
